(19) United States
(12) Patent Application Publication
(10) Pub. No.: US 2024/0406335 A1
(43) Pub. Date: Dec. 5, 2024

(54) IMAGE FORMING APPARATUS AND STORAGE MEDIUM

(71) Applicant: Konica Minolta, Inc., Tokyo (JP)

(72) Inventor: Mieko MITA, Tokyo (JP)

(73) Assignee: Konica Minolta, Inc., Tokyo (JP)

(21) Appl. No.: 18/675,334

(22) Filed: May 28, 2024

(30) Foreign Application Priority Data
May 30, 2023 (JP) 2023-088506

(51) Int. Cl. H04N 1/60; G03G 15/00; G03G 15/01

(52) U.S. Cl. CPC H04N 1/6041; G03G 15/0189; G03G 15/5062

(57) ABSTRACT

An image forming apparatus including a hardware processor and an image former that forms a measurement pattern on a recording medium under control of the hardware processor, wherein the hardware processor acquires image data obtained by reading a recording medium surface on which the measurement pattern is formed, calculates gradation characteristics at positions of correction points arranged along a direction orthogonal to a conveyance direction of the recording medium on a basis of the acquired image data, and corrects density unevenness of the measurement pattern in the direction orthogonal to the conveyance direction by correction values at the positions of the correction points calculated on the basis of the gradation characteristics, and the measurement pattern includes a first image having a maximum gradation value, second images that are adjacent to the first image on an upstream side in the conveyance direction and whose gradation values change stepwise and in ascending order in the conveyance direction, and third images that are adjacent to the first image on a downstream side in the conveyance direction and whose gradation values change stepwise and in descending order in the conveyance direction.

### BACKGROUND OF THE INVENTION

### Technical Field

The present application claims priority to Japanese Application No. 202-088506 filed May 30, 2023.

### Description of Related Art

An image forming apparatus such as a printer or a copier forms a patch on a sheet and acquires a measurement value of a color of the patch from image data generated by reading a surface of the sheet. Next, the image forming apparatus performs calibration for controlling the color, density, and the like of the image to be constant on the basis of the measurement value (see JP 2010-256764A, and JP 2011-209355A).

### SUMMARY OF THE INVENTION

When a patch is formed on a sheet in an image forming apparatus, noise other than density unevenness may occur due to the influence of an edge effect or the like. The edge effect is a phenomenon in which a toner adhesion amount is large at an edge of a toner adhesion portion in the image and is small at a center of the toner adhesion portion.

Alternatively, when a patch formed on a sheet is read, noise other than density unevenness may occur due to the influence of flare or the like. Flare is a phenomenon in which color information of a measurement object cannot be accurately read due to an influence of an image around the measurement object.

When the noise is superimposed, an accurate measurement value cannot be acquired, resulting in a decrease in the accuracy of calibration.

In the inventions disclosed in JP 2010-256764A and JP 2011-209355A, the above-described problem is not considered, and therefore, there is a possibility that a value excluding the above-described noise cannot be measured.

An object of the present invention is to provide an image forming apparatus and a storage medium capable of correcting density unevenness with high accuracy.

To achieve at least one of the abovementioned objects, according to an aspect of the present invention, an image forming apparatus reflecting one aspect of the present invention includes: a hardware processor; and an image former that forms a measurement pattern on a recording medium under control of the hardware processor, wherein the hardware processor acquires image data obtained by reading a recording medium surface on which the measurement pattern is formed, calculates gradation characteristics at positions of correction points arranged along a direction orthogonal to a conveyance direction of the recording medium on a basis of the acquired image data, and corrects density unevenness of the measurement pattern in the direction orthogonal to the conveyance direction by correction values at the positions of the correction points calculated on the basis of the gradation characteristics, and the measurement pattern includes a first image having a maximum gradation value, second images that are adjacent to the first image on an upstream side in the conveyance direction and whose gradation values change stepwise and in ascending order in the conveyance direction, and third images that are adjacent to the first image on a downstream side in the conveyance direction and whose gradation values change stepwise and in descending order in the conveyance direction.

To achieve at least one of the abovementioned objects, according to yet another aspect of the present invention, a non-transitory computer readable storage medium reflecting one aspect of the present invention stores a program that causes a computer of an image forming apparatus comprising an image former that forms a measurement pattern on a recording medium to perform: acquiring image data obtained by reading a recording medium surface on which the measurement pattern is formed; and controlling the image former, wherein the program calculates gradation characteristics at positions of correction points arranged along a direction orthogonal to a conveyance direction of the recording medium on a basis of the acquired image data, and corrects density unevenness of the measurement pattern in the direction orthogonal to the conveyance direction by correction values at the positions of the correction points calculated on the basis of the gradation characteristics, and the measurement pattern includes a first image having a maximum gradation value, second images that are adjacent to the first image on an upstream side in the conveyance direction and whose gradation values change stepwise and in ascending order in the conveyance direction, and third images that are adjacent to the first image on a downstream side in the conveyance direction and whose gradation values change stepwise and in descending order in the conveyance direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic sectional view illustrating an entire configuration of an image forming apparatus of the present embodiment;

FIG. 2 is a block diagram illustrating a functional configuration of the image forming apparatus of the present embodiment;

FIG. 3 is a diagram illustrating an example of a measurement pattern;

FIG. 4 is a diagram illustrating an example of a sheet on which a plurality of measurement patterns are formed;

FIG. 5 is a diagram illustrating an example of a sheet on which a plurality of measurement patterns are formed;

FIG. 6 is a diagram illustrating an example of forming a plurality of measurement patterns on a sheet again;

FIG. 7 is a flowchart of correction processing; and

FIG. 8 is a diagram illustrating an example of a set window.

### DETAILED DESCRIPTION

Hereinafter, one or more embodiments of the present invention will be described with reference to the drawings. However, the scope of the invention is not limited to the disclosed embodiments.

### 1. Configuration of Image Forming Apparatus

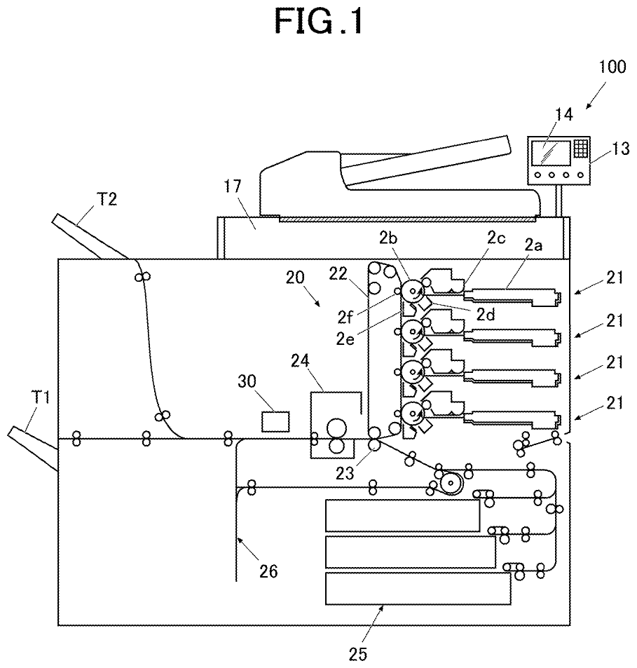

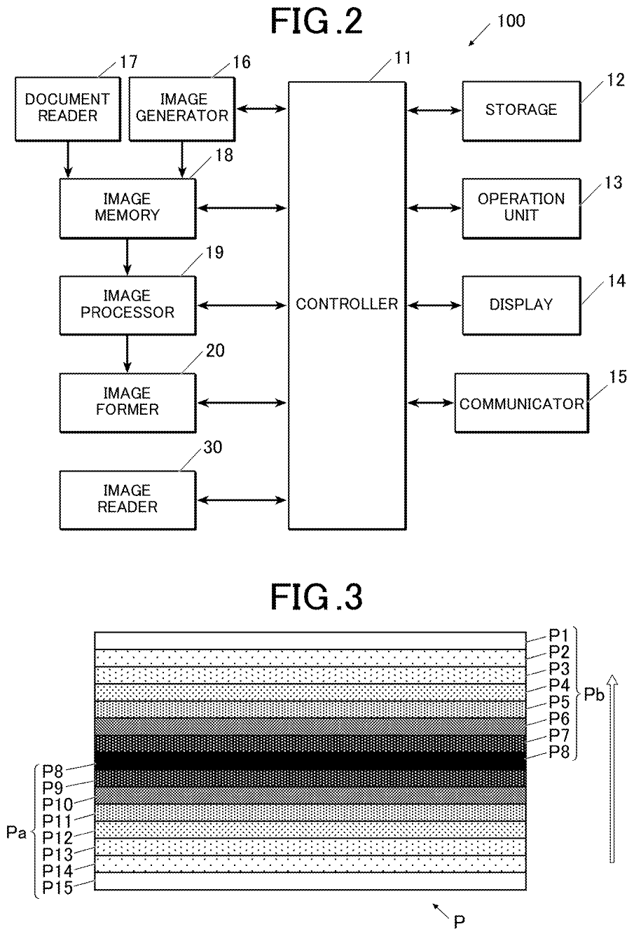

FIG. 1 is a schematic sectional view illustrating an entire configuration of an image forming apparatus 100. FIG. 2 is a block diagram illustrating a functional configuration of the image forming apparatus 100. The image forming apparatus 100 may form an image composed of a plurality of colors on a recording medium.

The recording medium is not limited to a particular one, and may be any known recording medium. Examples of the recording medium include a sheet such as plain paper or coated paper, or various media capable of fixing a coloring material attached to a surface of a sheet-shaped resin or the like. Hereinafter, it is assumed that the recording medium is a sheet.

As illustrated in FIG. 2, the image forming apparatus 100 may comprise a controller 11 (i.e., a hardware processor), a storage 12, an operation unit 13, a display 14, a communicator 15, an image generator 16, a document reader 17, an image memory 18, an image processor 19, an image former 20, an image reader 30, and the like.

The controller 11 my comprise a central processing unit (CPU), a random access memory (RAM), and the like.

The controller 11 may read various programs from the storage 12 and executes the programs to control each unit.

For example, the controller 11 may cause the image processor 19 to perform image processing on image data which is generated by the image generator 16 or the document reader 17 and stored in the image memory 18. Next, the controller 11 may cause the image former 20 to form an image on a sheet on the basis of the image data after the image processing.

The storage 12 may store programs which are readable by the controller 11 and the like, files used to execute the programs, and the like.

The storage 12 may be, for example, a large-capacity memory such as a hard disk.

The operation unit 13 may generate an operation signal according to user's operation and outputs the operation signal to the controller 11.

Examples of the operation unit 13 may comprise a keypad, and a touch panel which is formed integrally with the display 14.

The display 14 may display an operation screen or the like according to an instruction from the controller 11.

Examples of the display 14 may comprise a liquid crystal display (LCD), and an organic electro-luminescence display (OELD).

The communicator 15 may communicate with an external device on a network, for example, a user terminal, a server, another image forming apparatus, or the like.

The communicator 15 may receive data in which instruction contents for forming an image are described in a page description language (PDL), from a user terminal or the like through the network. Hereinafter, the data may be referred to as PDL data.

The image generator 16 may perform rasterization processing on the PDL data received from the communicator 15 and may generate image data in a bitmap format.

The image generator 16 may generate image data in which each pixel has pixel values of four colors including C (cyan), M (magenta), Y (yellow), and K (black).

Alternatively, the image generator 16 may generate image data having pixel values of three colors including R (red), G (green), and B (blue). Thereafter, the image generator 16 may perform color conversion processing on the image data having the pixel values of the three colors, thereby obtaining image data of four colors of C, M, Y, and K.

The pixel value may be a data value which indicates a tone of an image, and, for example, an 8-bit data value may indicate a tone of 0 to 255 gradation levels.

The image reader 17 may read a surface of a manually set sheet and generates image data in a bitmap format having pixel values of the respective colors of R, G, and B.

The controller 11, an exclusive color converter, or the like may convert the image data generated by the document reader 17 into image data of each color of C, M, Y, and K.

The document reader 17 may be, for example, a scanner or the like provided under a platen glass. In this case, the document reader 17 may comprise an automatic document feeder (ADF), and automatically feeds a document to the scanner.

The image memory 18 may be a buffer memory that temporarily retains the image data generated by the image generator 16 or the document reader 17.

The image memory 18 may be, for example, a dynamic RAM (DRAM).

The image processor 19 may read the image data from the image memory 18, and performs various types of image processing such as density correction processing, color correction processing, and halftone processing.

The density correction processing may be processing of converting each pixel value of image data so that the density characteristic of the image to be formed becomes a target density characteristic.

The color correction processing may be processing of converting the pixel value of each color of image data so that the color of the image becomes a target color.

The halftone processing may be processing of reproducing pseudo multi-gradation, such as screen processing and error diffusion processing using a dither method.

The image processor 19 may convert a pixel value according to a look-up table (LUT) in the density correction processing and the color correction processing. The LUT may be a table in which an input value and an output value are associated with other so that a target density characteristic or a target color can be reproduced.

The image former 20 may form an image composed of four colors of C, M, Y, and K on a sheet according to the gradation values of the four colors in each pixel of the image data output from the image processor 19.

As illustrated in FIG. 1, the image former 20 may comprise four writers 21, an intermediate transfer belt 22, a secondary transfer roller 23, a fixing unit 24, a sheet feed tray 25, and a reversing path 26.

The four writers 21 may be arranged in series (in tandem) along a belt surface of the intermediate transfer belt 22 and may form images of respective colors of CMYK on the intermediate transfer belt 22.

The writers 21 may differ only in the colors of images that are formed but have the same configuration.

As illustrated in FIG. 1, each writer 21 includes an exposer 2a, a photoreceptor 2b, a developer 2c, an electrifier 2d, a cleaner 2e, and a primary transfer roller 2f.

To form images, the image former 20 may cause the electrifier 2d to electrify the photoreceptor 2b in each writer 21. Next, in the image former 20, the surface of the photoreceptor 2b may be scanned with a light flux emitted from the exposer 2a on the basis of the image data, and an electrostatic latent image may be formed on the photoreceptor 2b. Next, in the image former 20, the developer 2c may supply a coloring material such as toner to develop the image and may form the image on the photoreceptor 2b.

Next, in the image former 20, the images formed on the four photoreceptors 2b may be sequentially superimposed and transferred (primary transfer) onto the intermediate transfer belt 22 by the respective primary transfer rollers 2f. Thus, the image former 20 may form an image of each color on the intermediate transfer belt 22. In the image former 20, the cleaner 2e may remove the coloring material remaining on the photoreceptor 2b after the primary transfer.

Next, in the image former 20, a sheet may be fed from the sheet feed tray 25.

Next, in the image former 20, the secondary transfer roller 23 may transfer (secondary transfer) the image from the intermediate transfer belt 22 onto the sheet.

Next, the image former 20 may use the fixing unit 24 to apply heat and pressure to the sheet on which secondary transfer is performed, to perform the fixing processing.

When images are formed on both sides of the sheet, the image former 20 may convey the sheet to the reversing path 26 to reverse the front side and rear side of the sheet, and then may convey the sheet to the secondary transfer roller 23 again.

As illustrated in FIG. 1, the image reader 30 may be located on a conveyance path of the sheet.

The image reader 30 may read a sheet surface on which an image is formed by the image former 20, and may generate read image data in a bitmap format having pixel values of the respective colors of R, G, and B. Next, the image reader 30 may output the generated read image data to the controller 11.

Examples of the image reader 30 may comprise a line sensor in which sensors such as a charge coupled device (CCD) are arranged in one dimension, and an area sensor in which sensors are arranged in two dimension.

In the image forming apparatus 100, the controller 11 may correct the density unevenness of the image formed by the image former 20.

To be specific, the controller 11 may cause the image former 20 to form a patch (measurement pattern) for correcting the density unevenness on a sheet. Next, the controller 11 may cause the image reader 30 to read the sheet surface and may generate read image data. Next, the controller 11 may acquire gradation values of the measurement pattern from the read image data. Next, the controller 11 may adjust an image forming condition in the image former 20 or an image processing condition of the image data according to the acquired gradation values.

### 2. Measurement Pattern

FIG. 3 illustrates an example of a measurement pattern P. An arrow in the drawing may indicate a sheet conveyance direction.

As illustrated in FIG. 3, the measurement pattern P may have a plurality of belt-shaped images P1 to P15 extending in a main scanning direction at a predetermined density. In the example illustrated in FIG. 3, black boundary lines may be provided to make the boundaries between the belt-shaped images P1 to P15 easier to see, but in practice, no boundary lines exist between the belt-shaped images P1 to P15.

The measurement pattern P may comprise an ascending-order portion Pa and a descending-order portion Pb.

The ascending-order portion Pa may comprise the belt-shaped images P8 to P15 that change stepwise in eight gradation levels from the minimum gradation value to the maximum gradation value from the upstream side to the downstream side in the sheet conveyance direction.

The descending-order portion Pb may comprise the belt-shaped images P1 to P8 that change stepwise in eight gradation levels from the maximum gradation value to the minimum gradation value from the upstream side to the downstream side in the sheet conveying direction.

The belt-shaped image P1 may be an image having the minimum gradation value in the descending-order portion Pb.

The belt-shaped image P8 may be an image having the maximum gradation value in the ascending-order portion Pa and the descending-order portion Pb.

The belt-shaped image P15 may be an image having the minimum gradation value in the ascending-order portion Pa.

That is, the measurement pattern P may comprise a first image (belt-shaped image P8) having the maximum gradation value.

The measurement pattern P may comprise second images (belt-shaped images P9 to P15) that are adjacent to the first image on the upstream side in the sheet conveyance direction and may have gradation values that change stepwise and in ascending order in the sheet conveyance direction.

The measurement pattern P may comprise third images (belt-shaped images P1 to P7) that are adjacent to the first image on the downstream side in the sheet conveyance direction and have gradation values that change stepwise and in descending order in the sheet conveyance direction.

This may make it possible to suppress the influence of the edge effect when the measurement pattern P is formed.

In the example illustrated in FIG. 3, the belt-shaped image P1 and the belt-shaped image P15 may be images having the same gradation value. The belt-shaped image P2 and the belt-shaped image P14 may be images having the same gradation value. The belt-shaped image P3 and the belt-shaped image P13 may be images having the same gradation value. The belt-shaped image P4 and the belt-shaped image P12 may be images having the same gradation value. The belt-shaped image P5 and the belt-shaped image P11 may be images having the same gradation value. The belt-shaped image P6 and the belt-shaped image P10 may be images having the same gradation value. The belt-shaped image P7 and the belt-shaped image P9 may be images having the same gradation value.

The belt-shaped image P1 and the belt-shaped image P15 may be images that do not have the same gradation value. The belt-shaped image P2 and the belt-shaped image P14 may be images that do not have the same gradation value. The belt-shaped image P3 and the belt-shaped image P13 may be images that do not have the same gradation value. The belt-shaped image P4 and the belt-shaped image P12 may be images that do not have the same gradation value. The belt-shaped image P5 and the belt-shaped image P11 may be images that do not have the same gradation value. The belt-shaped image P6 and the belt-shaped image P10 may be images that do not have the same gradation value. The belt-shaped image P7 and the belt-shaped image P9 may be images that do not have the same gradation value.

That is, the controller 11 sets the degree of change in the gradation value to be different between the second images (belt-shaped images P9 to P15) and the third images (belt-shaped images P1 to P7).

The use of the measurement pattern P having the above-described configuration may increase the number of gradation levels to be measured. In addition, it may be possible to reduce the influence of the difference between the gradation values measured in the ascending-order portion Pa and the descending-order portion Pb.

The belt-shaped image P7 may be an image having a gradation value closest to the gradation value (maximum gradation value) of the belt-shaped image P8 among the belt-shaped images P1 to P7.

The belt-shaped image P9 may be an image having a gradation value closest to the gradation value (maximum gradation value) of the belt-shaped image P8 among the belt-shaped images P9 to P15.

That is, the belt-shaped image P8 may be adjacent to ones having the gradation value closest to the maximum gradation value among the belt-shaped images P1 to P7 and the belt-shaped images P9 to P15.

In other words, the controller 11 may cause a portion (belt-shaped image P9) having a gradation value closest to the maximum gradation value among the second images (belt-shaped images P9 to P15) to be adjacent to the first image (belt-shaped image P8). The controller 11 may cause a portion (belt-shaped image P8) having a gradation value closest to the maximum gradation value among the third images (belt-shaped images P1 to P7) to be adjacent to the first image (belt-shaped image P8).

This may make it possible to minimize the influence of flare when the sheet on which the measurement pattern P is formed is read by the image reader 30. To be specific, in the belt-shaped image P8, it may be possible to suppress the influence of the sneaking of light from the image having a smaller gradation value than that of the belt-shaped image P8.

The number of belt-shaped images included in the measurement pattern P and the width of each belt-shaped image in the sub-scanning direction may not be limited to the example illustrated in FIG. 3.

The controller 11 may determine the number of belt-shaped images included in the measurement pattern P and the width of each belt-shaped image in the sub-scanning direction according to the following conditions. The conditions may comprise a type and basis weight of a sheet on which the measurement pattern P is formed, a print speed of the image forming apparatus 100, a toner color for forming an image, and the like.

That is, the controller 11 may determine the width of the measurement pattern in the sheet conveyance direction on the basis of at least one of the type and basis weight of a sheet, the print speed, and the print color.

The controller 11 may determine the number of gradation levels of the second images (belt-shaped images P9 to P15) and the third images (belt-shaped images P1 to P7) on the basis of at least one of the type and basis weight of a sheet, the print speed, and the print color.

For example, when as the type of the sheet, a sheet on which toner is easily placed is used, the controller 11 may set the width of each belt-shaped image in the sub-scanning direction to be smaller than a predetermined value (reference value). The sheet on which the toner is easily placed may be a coated sheet or the like.

For example, when as the type of the sheet, a sheet on which toner is less likely to be placed is used, the controller 11 may set the width of each belt-shaped image in the sub-scanning direction to be larger than the predetermined value (reference value). The sheet on which the toner is less likely to be placed may be, for example, a sheet having a smoothness lower than a predetermined threshold.

For example, when the basis weight of the sheet is larger than a predetermined threshold, the controller 11 may set the width of each belt-shaped image in the sub-scanning direction to be smaller than the predetermined value (reference value).

For example, when the basis weight of the sheet is equal to or less than a predetermined threshold, the controller 11 may set the width of each belt-shaped image in the sub-scanning direction to be larger than the predetermined value (reference value).

For example, when the print speed of the image forming apparatus 100 is equal to or lower than a predetermined threshold, the controller 11 may set the width of each belt-shaped image in the sub-scanning direction to be smaller than the predetermined value (reference value).

For example, when the print speed of the image forming apparatus 100 is higher than the predetermined threshold, the controller 11 may set the width of each belt-shaped image in the sub-scanning direction to be larger than the predetermined value (reference value).

For example, when the toner color for forming the image is a color that is easily placed on the sheet, the controller 11 may set the width of each belt-shaped image in the sub-scanning direction to be smaller than the predetermined value (reference value).

For example, when the toner color for forming the image is a color that is less likely to be placed on the sheet, the controller 11 may set the width of each belt-shaped image in the sub-scanning direction to be larger than the predetermined value (reference value).

For example, when as the type of the sheet, a sheet on which toner is easily placed is used, the controller 11 may set the number of belt-shaped images included in the measurement pattern P to be greater than a predetermined value (reference value). The sheet on which the toner is easily placed may be a coated sheet or the like.

For example, when as the type of the sheet, a sheet on which toner is less likely to be placed is used, the controller 11 may set the number of belt-shaped images included in the measurement pattern P to be less than the predetermined value (reference value). The sheet on which the toner is less likely to be placed may be, for example, a sheet having a smoothness lower than a predetermined threshold.

For example, when the basis weight of the sheet is larger than a predetermined threshold, the controller 11 may set the number of belt-shaped images included in the measurement pattern P to be greater than the predetermined value (reference value).

For example, when the basis weight of the sheet is equal to or less than the predetermined threshold, the controller 11 may set the number of belt-shaped images included in the measurement pattern P to be less than the predetermined value (reference value).

For example, when the print speed of the image forming apparatus 100 is equal to or lower than the predetermined threshold, the controller 11 may set the number of belt-shaped images included in the measurement pattern P to be greater than the predetermined value (reference value).

For example, when the print speed of the image forming apparatus 100 is higher than the predetermined threshold value, the controller 11 may set the number of belt-shaped images included in the measurement pattern P to be smaller than the predetermined value (reference value).

For example, when the toner color for forming the image is a color that is easily to be placed on the sheet, the controller 11 may set the number of belt-shaped images included in the measurement pattern P to be greater than the predetermined value (reference value).

For example, when the toner color for forming the image is a color that is less likely placed on the sheet, the controller 11 may set the number of belt-shaped images included in the measurement pattern P to be less than the predetermined value (reference value).

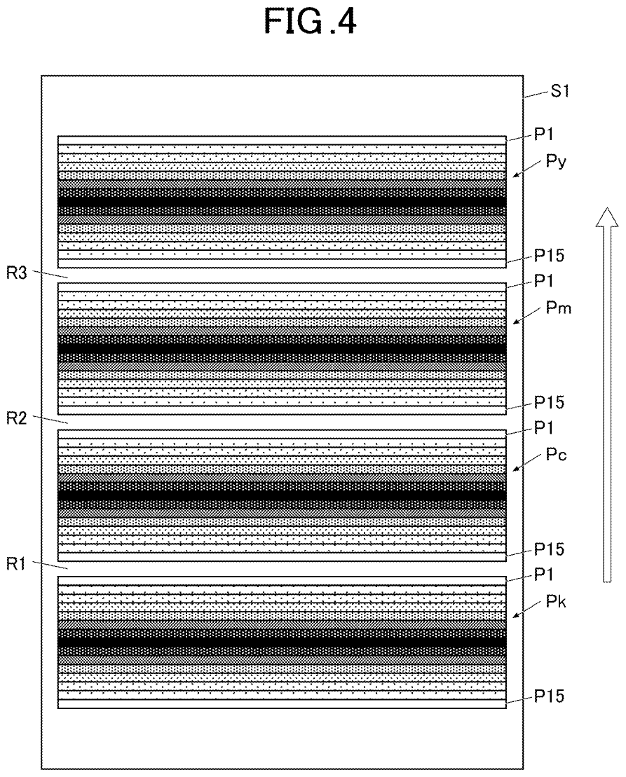

FIG. 4 illustrates an example of a sheet on which a plurality of measurement patterns may be formed. An arrow in the drawing may indicate a sheet conveyance direction.

In the example illustrated in FIG. 4, the controller 11 may cause the image former 20 to form measurement patterns Pk, Pc, Pm, and Py on a single sheet S1 from the upstream side in the sheet conveyance direction.

The measurement pattern Pk may be a measurement pattern formed by a toner of black (K).

The measurement pattern Pc may be a measurement pattern formed by a toner of cyan (C).

The measurement pattern Pm may be a measurement pattern formed by a toner of magenta (M).

The measurement pattern Py may be a measurement pattern formed by a toner of yellow (Y).

The controller 11 may provide a non-image forming region R1 having a coverage rate of 0% between the measurement patterns Pk and Pc.

The controller 11 may provide a non-image forming region R2 between the measurement patterns Pc and Pm.

The controller 11 may provide a non-image-forming region R3 between the measurement patterns Pm and Py.

That is, when forming a plurality of measurement patterns on a single sheet along the sheet conveyance direction, the controller 11 may arrange the non-image forming regions between the plurality of measurement patterns.

This may make it possible to prevent the measurement patterns from being formed adjacent to each other.

Accordingly, it may be possible to minimize the influence of flare when the sheet on which the measurement patterns P are formed is read by the image reader 30. To be specific, it may be possible to suppress the influence of sneaking of light between the adjacent measurement patterns.

As shown in FIG. 4, the non-image forming regions R1 to R3 each may be adjacent to the belt-shaped images having the minimum gradation value included in the adjacent measurement patterns.

To be specific, the non-image forming region R1 may be adjacent to the belt-shaped image P1 included in the measurement pattern Pk and the belt-shaped image P15 included in the measurement pattern Pc.

The non-image forming region R2 may be adjacent to the belt-shaped image P1 included in the measurement pattern Pc and the belt-shaped image P15 included in the measurement pattern Pm.

The non-image forming region R3 may be adjacent to the belt-shaped image P1 included in the measurement pattern Pm and the belt-shaped image P15 included in the measurement pattern Py.

That is, the non-image forming regions R1 to R3 each may be adjacent to belt-shaped images having a gradation value closest to the gradation value of the non-image forming regions R1 to R3, among the belt-shaped images P1 to P15 included in the measurement patterns.

In other words, the controller 11 may set a portion (belt-shaped image P15) among the second images (belt-shaped images P9 to P15) to be adjacent to the non-image forming region, the portion having a gradation value closest to the gradation value of the non-image forming region. The controller 11 may set a portion (belt-shaped image P1) among the third images (belt-shaped images P1 to P7) to be adjacent to the non-image forming region, the portion having a gradation value closest to the gradation value of the non-image forming region.

This may make it possible to minimize the influence of flare when the sheet on which the measurement pattern P is formed is read by the image reader 30. To be specific, it may be possible to suppress the influence of sneaking of light between the adjacent measurement patterns.

In the example illustrated in FIG. 4, the controller 11 may cause the image former 20 to form, on a sheet S1, four measurement patterns which are the measurement patterns Pk, Pc, Pm, and Py. However, the colors and the number of measurement patterns to be formed on a single sheet by the image former 20 may not be limited thereto.

That is, the controller 11 may arrange, on a single sheet, two or more measurement patterns formed in the same print color and having the same configuration along the sheet conveyance direction.

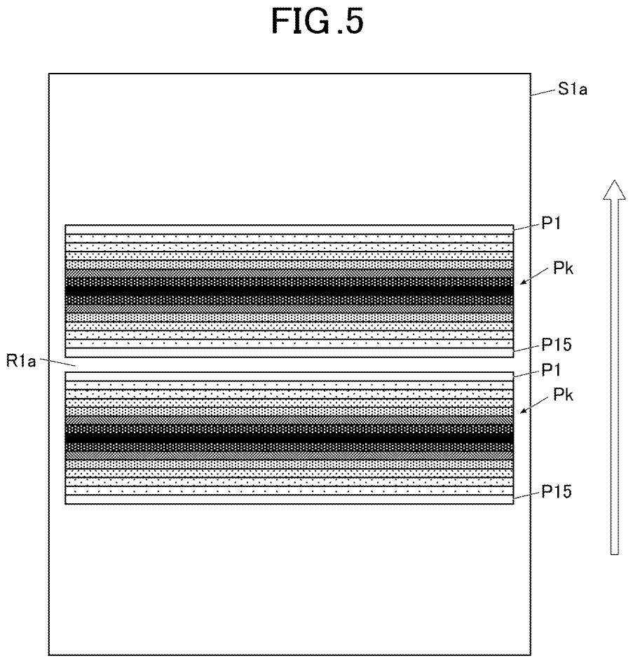

FIG. 5 illustrates an example of two measurement patterns formed in the same print color and having the same configuration along the sheet conveyance direction on a single sheet. An arrow in the drawing may indicate a sheet conveyance direction.

In the example illustrated in FIG. 5, the controller 11 may cause the image former 20 to form two measurement patterns Pk along the sheet conveyance direction on a single sheet S1a.

The controller 11 may provide a non-image forming region R1a between the two measurement patterns Pk.

This may make it possible to correct the density unevenness in the sub-scanning direction on the basis of the gradation values acquired from the plurality of measurement patterns arranged along the sub-scanning direction.

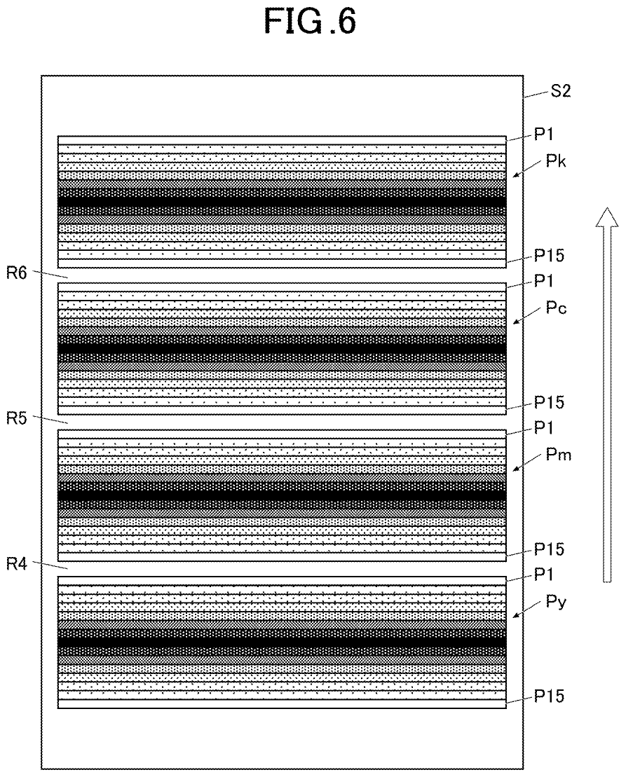

FIG. 6 illustrates an example in which after the controller 11 may cause the image former 20 to form the measurement patterns illustrated in FIG. 4 and may correct the density unevenness, measurement patterns may be formed with toners of a plurality of colors on a single sheet S2 again. An arrow in the drawing may indicate a sheet conveyance direction.

In the example illustrated in FIG. 6, the controller 11 may cause the image former 20 to form the measurement patterns Py, Pm, Pc, and Pk on the single sheet S2 from the upstream side in the sheet conveyance direction.

That is, the controller 11 may form the measurement patterns on the sheet S2 with toners of a plurality of colors in the reverse order to the order of the measurement patterns on the sheet S1 illustrated in FIG. 4.

In other words, the controller 11 may form measurement patterns for every plurality of colors along the sheet conveyance direction on a first recording medium (sheet S1). Next, the controller 11 may correct the density unevenness in the direction orthogonal to the sheet conveyance direction on the basis of the measurement patterns formed on the first recording medium. Next, the controller 11 may form, on a second recording medium (sheet S2), an image in which the image including the plurality of measurement patterns formed on the first recording medium is reversed in the paper conveyance direction. Next, the controller 11 may correct the density unevenness in the direction orthogonal to the sheet conveyance direction on the basis of the measurement patterns formed on the second recording medium.

That is, the controller 11 may correct the density unevenness on the basis of the image data in which the measurement patterns are arranged for every plurality of colors along the sheet conveyance direction on the first recording medium (sheet S1) and the image data in which the plurality of measurement patterns arranged on the first recording medium are arranged on the second recording medium (sheet S2) in the reverse order in the sheet conveyance direction.

This may make it possible to set the formation positions of the measurement patterns in the sub-scanning direction to be different between the first recording medium (sheet S1) and the second recording medium (sheet S2). Therefore, it may be possible to correct the density unevenness in the sub-scanning direction.

As illustrated in FIG. 6, the controller 11 may provide a non-image forming region R4 having a coverage rate of 0% between the measurement patterns Py and Pm.

The controller 11 may provide a non-image forming region R5 between the measurement patterns Pm and Pc.

The controller 11 may provide a non-image forming region R6 between the measurement patterns Pc and Pk.

### 3. Operation of Image Forming Apparatus

Next, operation of the image forming apparatuses 100 will be described.

Upon receiving an instruction to execute correction processing from a user via the operation unit 13, for example, the controller 11 of the image forming apparatus 100 may execute the correction processing.

The controller 11 may cooperate with a program stored in the storage 12 to execute the correction processing.

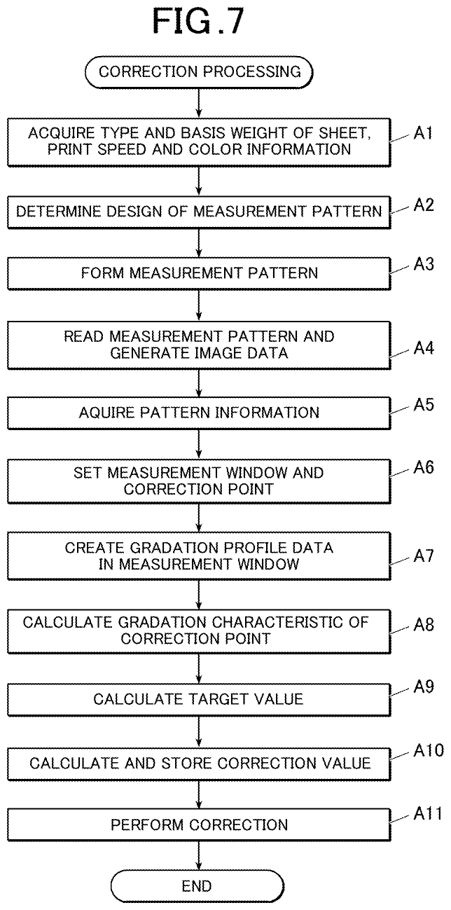

FIG. 7 illustrates a flowchart of the correction processing.

### Correction Processing

The controller 11 may acquire the type and basis weight of the sheet on which the measurement patterns are formed, the print speed of the image forming apparatus 100, and the color information as information on the toner color for forming the image (step A1).

The controller 11 may acquire the above-described information, for example, by a user's input operation via the operation unit 13.

When the above-described information is stored in the storage 12 in advance, the controller 11 may acquire the above-described information from the storage 12.

When the above-described information is included in the setting information of the print job that has been received by the controller 11 via the communicator 15, the controller 11 may acquire the above-described information from the setting information.

Next, the controller 11 determines the design of the measurement patterns on the basis of the information acquired in step A1 (step A2). To be specific, the controller 11 may determine the number of belt-shaped images included in the measurement pattern and the width of each belt-shaped image in the sub-scanning direction.

Next, the controller 11 may cause the image former 20 to form the measurement patterns determined in step A2 on a sheet (step A3).

Next, the controller 11 may cause the image reader 30 to read the sheet surface on which the measurement patterns are formed in step A3, and may generate a read image (step A4).

That is, the controller 11 may acquire image data obtained by reading the sheet surface on which the measurement patterns are formed. The controller 11 functions as an acquirer.

Next, the controller 11 may acquire pattern information on the measurement patterns (step A5).

The pattern information may comprise information on the arrangement position, size, color, and the like of each measurement pattern on the sheet.

To be specific, the controller 11 may acquire the pattern information from image data generated by arranging the measurement patterns when the measurement patterns are formed.

The information on the arrangement position of each measurement pattern may comprise, for example, the coordinate position of a pixel at a starting point of the measurement pattern, and the coordinate positions of the pixels at four corners of the measurement pattern. The coordinate position of a pixel may be, for example, a coordinate position in the main scanning direction x and the sub-scanning direction y with the starting point of the sheet as the origin.

The information on the size of the measurement pattern may indicate, for example, the length (the number of pixels) of the measurement pattern in the main scanning direction x and the sub-scanning direction y.

The information on the color of the measurement pattern may indicate, for example, the pixel value of each color of C, M, Y, and K set in the measurement pattern.

Next, the controller 11 may set measurement windows and correction points in the read image data generated by the image reader 30 on the basis of the pattern information acquired in step A5 (step A6).

To be specific, the controller 11 may set a plurality of measurement windows along the main scanning direction x in each measurement pattern.

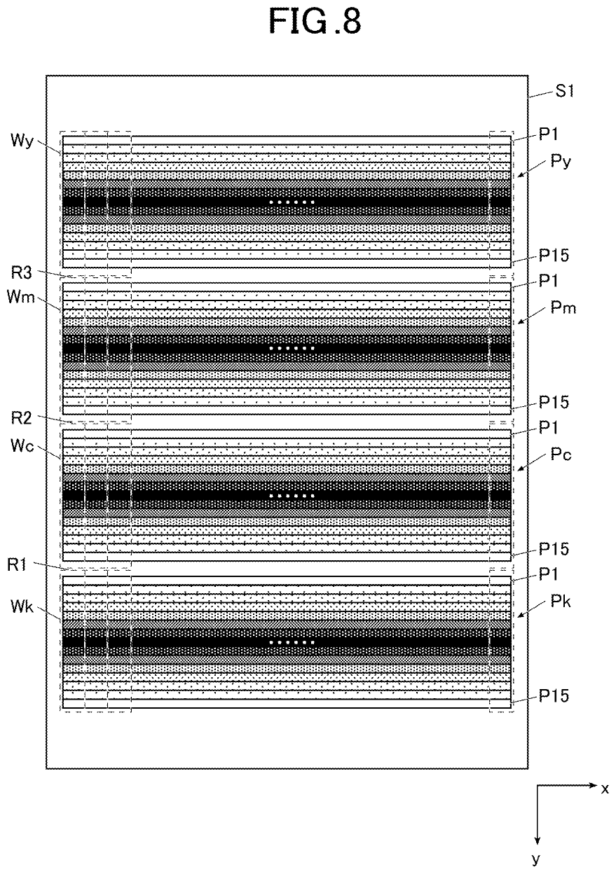

FIG. 8 illustrates an example in which a measurement window W may be set in the read image data obtained by reading the sheet on which the measurement patterns illustrated in FIG. 4 are formed.

In the example illustrated in FIG. 8, the controller 11 may set measurement windows Wk, Wc, Wm, and Wy in the respective measurement patterns Pk, Pc, Pm, and Py. The controller 11 may set a plurality of measurement windows Wk, Wc, Wm, Wy from one end to the other end in the main scanning direction x of the measurement pattern Pk, Pc, Pm, Py.

When the number of pixels of the measurement window W in the main scanning direction x is represented by N, it may be satisfied with N≥1.

When the number of pixels of the measurement window W in the sub-scanning direction y is represented by M, M may represent the number of pixels including the width of the measurement pattern in the sub-scanning direction y and the non-image forming region.

For example, the measurement window Wm may comprise, in the sub-scanning direction y, the entire measurement pattern Pm, a portion of the non-image forming region R2, and a portion of the non-image forming region R3.

The controller 11 may set one correction point sequence in which a plurality of correction points (pixels) are arranged along the main scanning direction x in the sheet S1.

When the number N of pixels of the measurement window W in the main scanning direction x satisfies N=1, the measurement window W and the position of the correction point may coincide with each other in the main scanning direction x.

When the number N of pixels of the measurement window W in the main scanning direction x satisfies N>1, the center position in the width in the main scanning direction x of the measurement window W and the position of the correction point may coincide with each other in the main scanning direction x.

Next, the controller 11 may acquire the gradation values in each measurement window set in step A6, and may create gradation profile data (step A7).

By creating the gradation profile data of the images (measurement pattern) whose the gradation values change stepwise, the controller 11 may suppress the influence of the screen pattern interference streaks (interference fringes). The screen pattern interference streaks may be a phenomenon caused by interference between a period of cutting recesses and projections periodically formed on the surface of the photoreceptor 2b and a period of the screen pattern.

Next, the controller 11 may calculate gradation characteristics at the respective correction points set in step A6 on the basis of the gradation profile data created in step A7 (step A8). The gradation characteristic (y curve) may indicate a relationship between input gradation and a density of an output image.

When the measurement pattern P has the following configuration, the controller 11 may calculate, in step A8, an average value of the gradation values of the images having the same gradation value. To be specific, the belt-shaped image P1 and the belt-shaped image P15 of the measurement pattern P may be images having the same gradation value. In addition, the belt-shaped image P2 and the belt-shaped image P14 of the measurement pattern P may be images having the same gradation value. In addition, the belt-shaped image P3 and the belt-shaped image P13 of the measurement pattern P may be images having the same gradation value. In addition, the belt-shaped image P4 and the belt-shaped image P12 of the measurement pattern P may be images having the same gradation value. In addition, the belt-shaped image P5 and the belt-shaped image P11 of the measurement pattern P may be images having the same gradation value. In addition, the belt-shaped image P6 and the belt-shaped image P10 of the measurement pattern P may be images having the same gradation value. In addition, the belt-shaped image P7 and the belt-shaped image P9 of the measurement pattern P may be images having the same gradation value.

That is, the controller 11 may calculate an average value of the gradation values of the belt-shaped image P1 and the belt-shaped image P15 in each measurement window. The controller 11 may calculate an average value of the gradation values of the belt-shaped image P2 and the belt-shaped image P14 in each measurement window. The controller 11 may calculate an average value of the gradation values of the belt-shaped image P3 and the belt-shaped image P13 in each measurement window. The controller 11 may calculate an average value of the gradation values of the belt-shaped image P4 and the belt-shaped image P12 in each measurement window. The controller 11 may calculate an average value of the gradation values of the belt-shaped image P5 and the belt-shaped image P11 in each measurement window. The controller 11 may calculate an average value of the gradation values of the belt-shaped image P6 and the belt-shaped image P10 in each measurement window. The controller 11 may calculate an average value of the gradation values of the belt-shaped image P7 and the belt-shaped image P9 in each measurement window.

When the measurement pattern P has the following configuration, the controller 11 may sort the acquired gradation values in ascending order or descending order in step A8. To be specific, the belt-shaped image P1 and the belt-shaped image P15 of the measurement pattern P may not be images having the same gradation value. In addition, the belt-shaped image P2 and the belt-shaped image P14 of the measurement pattern P may not be images having the same gradation value. In addition, the belt-shaped image P3 and the belt-shaped image P13 of the measurement pattern P may not be images having the same gradation value. In addition, the belt-shaped image P4 and the belt-shaped image P12 of the measurement pattern P may not be images having the same gradation value. In addition, the belt-shaped image P5 and the belt-shaped image P11 of the measurement pattern P may not be images having the same gradation value. In addition, the belt-shaped image P6 and the belt-shaped image P10 of the measurement pattern P may not be images having the same gradation value. In addition, the belt-shaped image P7 and the belt-shaped image P9 of the measurement pattern P may not be images having the same gradation value.

That is, in step A8, the controller 11 may acquire the gradation values of the belt-shaped images P1 to P15 in each measurement window, and may sort the gradation values in ascending order or descending order.

Next, the controller 11 may calculate a target value which is an average value of the gradation characteristics at each correction point calculated in step A8 (step A9). The average value of the gradation characteristics at each correction point may be an average value of a plurality of gradation characteristics calculated at the respective correction points.

Alternatively, in step A9, the controller 11 may set a predetermined gradation characteristic as the target value.

Next, the controller 11 may calculate a correction value on the basis of the target value calculated in step A9, and stores the correction value in the storage 12 (step A10).

In step A10, the controller 11 may calculate a correction value for each of the correction points so that the gradation characteristic at each correction point coincide with the target value calculated in step A9.

Next, at each correction point set in step A6, the controller 11 may perform correction using the correction value for each of the correction points calculated in step A10 (step A11), and ends the present processing. To be specific, the controller 11 may adjust the image processing conditions by updating the LUT used for the density correction processing and the color correction processing. Alternatively, the controller 11 may adjust image forming conditions such as a development bias potential and a laser power of a laser beam at the time of exposure.

### 4. Effects

As described above, the image forming apparatus 100 of the present embodiment may comprise the controller 11.

The image forming apparatus 100 according to the present embodiment may comprise an image former 20 that forms measurement patterns on a recording medium (sheet) under the control of the controller 11.

The image forming apparatus 100 according to the present embodiment may comprise an acquirer (controller 11) that acquires image data obtained by reading the surface of the recording medium on which the measurement patterns are formed.

The controller 11 may calculate the gradation characteristics at the positions of the correction points arranged along the direction orthogonal to the conveyance direction of the recording medium on the basis of the image data acquired by the acquirer. The controller 11 may correct the density unevenness in the direction orthogonal to the conveyance direction of the measurement patterns by the correction values at the positions of the correction points calculated on the basis of the gradation characteristics.

The measurement pattern of the present embodiment may comprise the first image having the maximum gradation value.

The measurement pattern of the present embodiment may comprise the second images which are adjacent to the first image on the upstream side in the conveyance direction and whose gradation values change stepwise and in ascending order in the conveyance direction.

The measurement pattern of the present embodiment may comprise the third images that are adjacent to the first image on the downstream side in the conveyance direction and whose gradation values change stepwise and in descending order in the conveyance direction.

This may make it possible to suppress the influence of the edge effect when the measurement pattern P is formed. It may be possible to minimize the influence of flare when the sheet on which the measurement patterns are formed is read by the image reader 30. That is, noise other than the density unevenness may be suppressed. Furthermore, since the density unevenness in the direction (main scanning direction) orthogonal to the sheet conveyance direction may be corrected, the density unevenness may be corrected with high accuracy.

In the image forming apparatus 100 according to the present embodiment, when a plurality of measurement patterns are formed on a single recording medium along the conveyance direction, the controller 11 may arrange non-image forming regions between the plurality of measurement patterns.

This may make it possible to prevent the measurement patterns from being formed adjacent to each other.

Therefore, it may be possible to minimize the influence of flare when the sheet on which the measurement patterns are formed is read by the image reader 30.

In the image forming apparatus 100 of the present embodiment, the controller 11 may set a portion among the second images and the third images to be adjacent to the first image, the portion having a gradation value closest to the maximum gradation value. The controller 11 may set a portion among the second images and the third images to be adjacent to the non-image forming region, the portion having a gradation value closest to a gradation value of the non-image forming region.

This may make it possible to minimize the influence of flare when the sheet on which the measurement patterns are formed is read by the image reader 30.

In the image forming apparatus 100 of the present embodiment, the controller 11 may set the degree of change in the gradation value to be different between the second images and the third images.

This may make it possible to increase the number of gradation levels to be measured. In addition, it may be possible to reduce the influence of the difference between the gradation values measured in the ascending-order portion Pa and the descending-order portion Pb.

In the image forming apparatus 100 according to the present embodiment, the controller 11 may determine the width of the measurement pattern in the conveyance direction on the basis of at least one of the type and basis weight of the recording medium (sheet), the print speed, and the print color.

This may make it possible to determine the optimum width of the measurement pattern in the sheet conveyance direction according to at least one of the type and basis weight of the sheet, the print speed, and the print color. Therefore, it may be possible to improve the robustness of the measurement pattern.

In the image forming apparatus 100 of the present embodiment, the controller 11 may determine the number of gradation levels of the second images and the third images on the basis of at least one of the type and basis weight of the recording medium (sheet), the print speed, and the print color.

This may make it possible to determine the optimum number of gradation levels of the measurement pattern according to at least one of the type and basis weight of the sheet, the print speed, and the print color. Therefore, it may be possible to improve measurement accuracy in the measurement pattern.

In the image forming apparatus 100 of the present embodiment, the controller 11 may calculate the gradation characteristics at the positions of the correction points on the basis of the gradation profile data in the measurement pattern included in the image data.

By creating the gradation profile data of the images (measurement pattern) whose the gradation values change stepwise, the controller 11 may suppress the influence of the screen pattern interference streaks (interference fringes).

In the image forming apparatus 100 according to the present embodiment, the controller 11 may arrange, on a single recording medium, two or more measurement patterns formed in the same print color and having the same configuration along the conveyance direction.

This may make it possible to correct the density unevenness in the sub-scanning direction on the basis of the gradation values acquired from the plurality of measurement patterns arranged along the sub-scanning direction.

In the image forming apparatus 100 according to the present embodiment, the controller 11 may correct the density unevenness on the basis of the image data in which the measurement patterns are arranged for every plurality of colors along the sheet conveyance direction on the first recording medium and the image data in which the plurality of measurement patterns arranged on the first recording medium are arranged on the second recording medium in the reverse order in the sheet conveyance direction.

This may make it possible to set the formation positions of the measurement patterns in the sub-scanning direction to be different between the first recording medium (sheet S1) and the second recording medium (sheet S2). Accordingly, it may be possible to correct the density unevenness in the sub-scanning direction.

The above-described embodiment may be a preferred example of the present invention, and the present invention may not be limited thereto. Appropriate changes may be made without departing from the spirit of the present invention.

For example, not only the image forming apparatus 100 but also an image processing apparatus such as a general-purpose PC may comprise a controller, and the controller may execute the correction processing.

As a computer-readable medium of the program, a nonvolatile memory such as a ROM or a flash memory, or a portable recording medium such as a CD-ROM may be applied. A carrier wave may also be applied as a medium for providing program data via a communication line.

Although embodiments of the present invention have been described and illustrated in detail, the disclosed embodiments may be made for purposes of illustration and example only and not limitation. The scope of the present invention should be interpreted by terms of the appended claims.

The entire disclosure of Japanese Patent Application No. 2023-088506 filed on May 30, 2023 is incorporated herein by reference in its entirety.

What is claimed is:

1. An image forming apparatus comprising:
a hardware processor; and
an image former that forms a measurement pattern on a recording medium under control of the hardware processor, wherein
the hardware processor acquires image data obtained by reading a recording medium surface on which the measurement pattern is formed, calculates gradation characteristics at positions of correction points arranged along a direction orthogonal to a conveyance direction of the recording medium on a basis of the acquired image data, and corrects density unevenness of the measurement pattern in the direction orthogonal to the conveyance direction by correction values at the positions of the correction points calculated on the basis of the gradation characteristics, and
the measurement pattern includes
a first image having a maximum gradation value,
second images that are adjacent to the first image on an upstream side in the conveyance direction and whose gradation values change stepwise and in ascending order in the conveyance direction, and
third images that are adjacent to the first image on a downstream side in the conveyance direction and whose gradation values change stepwise and in descending order in the conveyance direction.

2. The image forming apparatus according to claim 1, wherein when a plurality of the measurement patterns are formed on a single sheet of the recording medium along the conveyance direction, the hardware processor arranges non-image forming regions between the plurality of the measurement patterns.

3. The image forming apparatus according to claim 2, wherein the hardware processor sets a portion among the second images and the third images to be adjacent to the first image, the portion having a gradation value closest to a maximum gradation value, and sets a portion among the second images and the third images to be adjacent to the non-image forming region, the portion having a gradation value closest to a gradation value of the non-image forming region.

4. The image forming apparatus according to claim 1, wherein the hardware processor sets a degree of change in the gradation value to be different between the second images and the third images.

5. The image forming apparatus according to claim 1, wherein the hardware processor determines a width of the measurement pattern in the conveyance direction on a basis of at least one of a type and basis weight of the recording medium, a print speed, and a print color.

6. The image forming apparatus according to claim 1, wherein the hardware processor determines the number of gradation levels of the second images and the third images on a basis of at least one of a type and basis weight of the recording medium, a print speed, and a print color.

7. The image forming apparatus according to claim 1, wherein the hardware processor calculates the gradation characteristics at the positions of the correction points on a basis of gradation profile data in the measurement pattern included in the image data.

8. The image forming apparatus according to claim 1, wherein the hardware processor arranges, on a single recording medium, two or more measurement patterns formed in the same print color and having the same configuration along the conveyance direction.

9. The image forming apparatus according to claim 1, wherein the hardware processor corrects the density unevenness on a basis of image data in which the measurement patterns are arranged for every plurality of colors along the conveyance direction on a first recording medium and image data in which the plurality of measurement patterns arranged on the first recording medium are arranged on a second recording medium in a reverse order in the conveyance direction.

10. A non-transitory computer readable storage medium storing a program causing a computer of an image forming apparatus comprising an image former that forms a measurement pattern on a recording medium to perform:
acquiring image data obtained by reading a recording medium surface on which the measurement pattern is formed; and
controlling the image former, wherein
the program causes the computer to calculate gradation characteristics at positions of correction points arranged along a direction orthogonal to a conveyance direction of the recording medium on a basis of the acquired image data, and correct density unevenness of the measurement pattern in the direction orthogonal to the conveyance direction by correction values at the positions of the correction points calculated on the basis of the gradation characteristics, and
the measurement pattern includes
a first image having a maximum gradation value,
second images that are adjacent to the first image on an upstream side in the conveyance direction and whose gradation values change stepwise and in ascending order in the conveyance direction, and
third images that are adjacent to the first image on a downstream side in the conveyance direction and whose gradation values change stepwise and in descending order in the conveyance direction.
